(19) United States
(12) Patent Application Publication
(10) Pub. No.: US 2016/0174457 A1
(43) Pub. Date: Jun. 23, 2016

(54) Consumer Seed Packaging System

(71) Applicant: James Lynch, Georgetown, MA (US)

(72) Inventor: James Lynch, Georgetown, MA (US)

(21) Appl. No.: 14/064,570

(22) Filed: Oct. 28, 2013

(51) Int. Cl. A01C 1/04; G06F 17/30

(52) U.S. Cl. CPC A01C 1/044; G06F 17/30879

(57) ABSTRACT

A seed packaging system for transporting seeds. A paper element containing plant seeds which displays a graphic of the plant and an adhesive backing like that of a stamp. The paper element is used as an accessory in gifting cards or packages such that the recipient may remove the paper element, bury it and grow the plant depicted on the graphic.

### BACKGROUND OF THE INVENTION

1. Field of the Invention

A consumer seed packaging system.

Specifically, a seed packaging system that resembles a stamp or sticker that is used in collecting, gift giving and trading such that the recipient can bury the stamp and grow the intended plant.

2. Brief Description of the Invention

The present invention encompasses the packaging of seeds in a method that resembles that of a postage stamp or sticker. Stamps by design are a graphic element on a paper substrate with an adhesive backing and may be applied to a number of surfaces. Stamps are used as a decoration in gift giving and are communally used to display emotion, feeling, or to celebrate an event. Stamps are also widely collectable and are commonly found as a hobby or pastime with both children and adults worldwide. Sending flowers or a fruit basket are also common methods of showing appreciation or conveying your thoughts of appreciation or sorrow. The problem with flowers or fruit however is they both have a short life expectancy. Flowers quickly begin to wilt once cut from the plant and sending fresh fruit needs to be done quickly and with refrigeration as the food begins to decay rapidly once exposed to the air. It is also a problem with sending flowers and fruit as they are often heavy and are difficult to package, often adding significant cost to sending them through the mail or requiring special shipping methods.

It is the intention of the present invention to provide the means to send prepackaged seeds, described herein as a seed stamp, in a graphic adhesive package such that the recipient may plant the seeds when appropriate and enjoy the gift for years to come, making the thoughtful gesture more meaningful. As an additional feature of the seed stamp, a QR code is printed on the back of the stamp element under the adhesive layer which is clearly visible to the recipient of the stamp once the stamp is removed from the object in which it was attached. The receiver then scans the QR code via a smart phone or other suitable device which in turn launches a web site in which further information may be found. Information may be in the form of, but not limited to planting of the seeds, care taking of the plant, a personal gesture or greeting, company website or product promotion in the case where the stamp was affixed to a product or device for advertising purposes.

In order to accomplish connecting a personal gesture to the QR tag, a general website is assigned to the QR tag on the back of the stamp and the back of the instructions card. When the sender of the seed stamp scans in the QR tag on the back of the instruction card, they are taken to a registration screen where they fill out personal information and a personal gesture as desired information. Personal gesture can include text, voice, pictures, and video. The website returns with a unique serial code that the sender records on the gift or card the seed stamp is attached to.

When the recipient of the card or gift receives the object with the seed stamp attached, they peel off the seed stamp and scan in the back QR tag. A website will appear with planting instructions, frequently asked questions, promotional activities, and ability to enter in a unique serial code. Once the receiver enters the unique serial code, they will be presented with the personal gesture from the sender.

Multiple seed stamps can be registered with the same pin number such as the case where the sender wants every receiver to see the same personal gesture. Unique serial numbers can also be printed on the card or gift in bulk.

In summary, a seed stamp as described in the present invention provides the gift giver with the ability to send either flowers, food or even a tree with the ease of providing seeds contained within a stamp with the added benefit of a personal greeting or message via smart graphic tag technology.

The present invention comprises a top paper element, a soluble layer, seeds, bottom paper element and adhesive layer. Construction of the seed stamp from the top down comprises a first graphic image on the top paper element depicting the flower and/or occasion of the event in which the stamp is being given. Beneath the top paper layer is a soluble layer, which acts to delaminate the seed stamp once moist to help expose the seeds and accelerate germination. Under the soluble layer is a seed layer, which incorporates the seeds of the intended flower or plant depicted in the top graphic layer. Directly under the seed layer is a bottom paper layer which contacts the seeds and top layer and has adhesive strong enough to bond the seeds and top layer together to form the enclosure of the seed stamp. On the bottom side of the bottom paper layer is another graphic image of a scan-able code by electronic or smart phone readers. Lastly, covering the scan-able code is a less aggressive clear adhesive intending to temporarily affix the entire seed stamp to a package to allow the seed stamp to be easily removed without damaging the paper element or the seeds contained inside.

Additional layers may include self expanding material such as foam or fertilizer intending to break apart the top and bottom layers of paper exposing the seeds for improved germination. The added benefit of the fertilizer is to help the seeds grow.

In terms of construction, seeds may also be biased towards the middle for better edge sealing of the stamp where edge sealing can be performed by glue, stamping, or beveling. The purpose of the edge sealing is for easier removal of stamp from the backing and hide any partially cut seeds. As an added benefit, the edge sealing can help prolong the seed life by keeping out humidity but break down when soaked in water for a short period of time.

Additional materials can be used to aid the user during planting are inks on the paper that change color when soaked for a period of time that correlates with the optimal watering of the seeds. Other indicators for watering can include graphics that wash off or change their image or fade away if the paper is too dry for proper germination of the seeds in the soil.

The seed stamp may also be integral in the presentation or sale of a host product such as a cup of coffee or child's meal. The seed stamp can be located on the bottom of a cup for example where once the liquid in the cup is consumed, the seed stamp can be peeled off and placed into the cup along with dirt and water to grow the intended flower or plant. Further enhancements could include the seed stamp also functioning as a plant location marker where the graphic on the sticker depicts the plant to be grown and aids the user in the specific location of the buried seed stamp. Further enhancements of the cup could include supplying food for the seeds, acting as a rain catcher, and displaying a promotional brand message. For the case of a hot drink, the heat of the drink can help activate the seed for germination as heat has been shown to help grow certain types of seeds.

The seed stamp may also be used in combination with a universal gift giving means such as a gift card. A gift card is a base material such as plastic or paper that is fitted with a magnetic strip that can be read by electronic means which denotes the monitory value of the card. Once purchased by the gift giver, the gift card becomes a form of currency and allows the receiver of the gift card to purchase desirable items with the funds assigned to the gift card. The seed stamp may be embedded into the gift card substrate or affixed to the surface of the gift card in a manner as to not interfere with the magnetic strip thus allowing the gift card to retain electronic scanning means by magnetic card readers or other conventional methods. Once the value of the gift card has been depleted, the gift card may then be buried to provide the further gift of a bed of flowers, vegetables or a tree.

### SUMMARY OF THE INVENTION

The present invention embodies paper elements with seeds contained within the paper elements, an adhesive backing and a graphic image of the plant that were to grow if the seeds were to germinate. The composition of these elements will be referred to as a seed stamp.

Several methods of producing a seed stamp may be realized with one example being described below to assist the reader in understanding the details of the system. The embodiment includes a first paper element that has been printed with a graphic depicting either the plant that is to grow or a holiday or special occasion theme, such as a baby shower or wedding. A second layer is then a seed layer which incorporates the seeds of the plant that is intended to grow. A third paper layer is then added to encapsulate the seed layer between the top and bottom paper layers. An adhesive layer is then applied to the bottom of the third paper layer to allow the seed stamp to be temporally fixed to an object for presentation and transportation purposes. After receiving the seed stamp, it is then a feature of the seed stamp that it may be easily removed from the object that it was adhered to such that it may be buried in soil either outside the home in the wild, in a garden or contained within a plant pot. Once buried and given the proper amount of water and light, the seeds for the plant depicted on the seed stamp graphic will begin to germinate.

Of significant importance in this construction of the seed stamp is the adhesive element itself and mechanical mounting means. For the seed stamp may be affixed to a variety of surfaces such as, but not limited to greeting cards, gift boxes, balloons, food products, appliances, jewelry, bottles, cups and clothing. Specific adhesives may be used for waterproofing, extreme temperatures, abrasive applications, flexible materials, wood, metal, plastics, rubber etc. The size of the seed stamp may also vary to fit the occasion or intended task and may range from a few square millimeters to one that is large enough to be affixed to an appliance box. The shape of the seed stamp may also be cut to that of a circle, square, rectangle, trapezoid, star or any shape obtainable by machinery or human methods.

Methods for printing the QR tag or other scannable technology may be performed by standard offset or digital printing technology as well as any other printing means that produces quality high enough to produce the desired outcome.

Although primarily intended for gift giving, scrapbooking and crafters, it is obvious to those skilled in the art that a seed stamp system described above may be use with other applications such as special events, giveaway items, coffee cups, cup holders, post cards, letters and official postage stamps used by the United States Postal System without departing from the spirit of the invention.

### BRIEF DESCRIPTION OF THE DRAWINGS

A preferred embodiment of the invention, illustrative of the best mode in which applicant has contemplated applying the principles of the invention, is set forth in the following description and drawings and will be particularly and distinctly pointed out and set forth in the claims of the formal application.

FIG. 1 Is a drawing of a typical seed stamp.

FIG. 2 Is a drawing of a seed stamp showing each layer of its composition

FIG. 3 Is a drawing of a seed stamp showing the variety of shapes and sizes.

FIG. 4 Is a drawing of a seed stamp showing it affixed to various objects

FIG. 5 Is a drawing of a seed stamp showing the variety of plants that may be grown.

FIG. 6 Is a drawing of a typical QR codes on the bottom of a seed stamp.

FIG. 7 Is a drawing of a typical scenario of a user scanning a code to launch a web site.

### DESCRIPTION OF THE PREFERRED EMBODIMENT

It is understood that while a certain form of the invention is illustrated, it is not to be limited to the specific form or arrangement of parts herein described and shown. It should be apparent to those skilled in the art that various changes may be made without departing from the scope of the invention and the invention is not to be considered limited to what is shown in the drawings and described in the specification structural elements be incorporated without departing from the scope of the invention. As such, although the description above contains much specificity, these should not be construed as limiting the scope of the invention but as merely providing illustrations of some of the presently preferred embodiments of this invention.

### DETAILED DESCRIPTION OF THE DRAWINGS

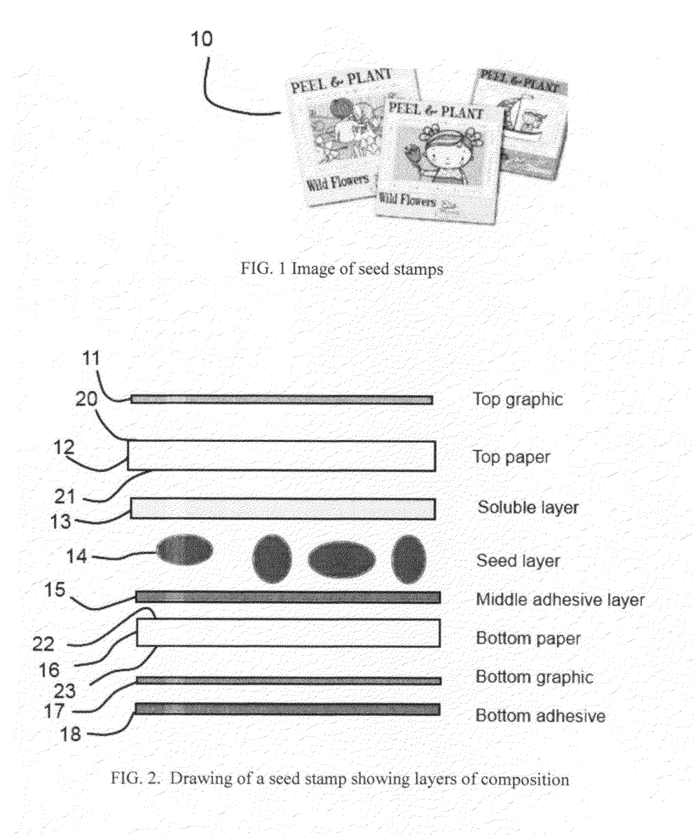

Referring to FIGS. 1-7 below, a seed stamp 10 is composed of a top graphic layer 11 that is printed on a top paper layer top side 20 of top paper layer 12. The top paper layer bottom side 21 of top paper layer 12 is then coated with a top adhesive layer 13 which bonds top paper layer 12 to a soluble layer 13. Soluble layer 13 then contacts seed layer 14 and fixes layers 11-13 to seed layer 14 respectively. Middle adhesive layer 15 then bonds a bottom paper layer top side 22 of bottom paper layer 16 to seed layer 14 and forms the body of the seed stamp 10. Bottom graphic layer 17 is then printed on a bottom paper layer bottom side 23 of bottom paper layer 16 and bottom adhesive 18 is then applied to the bottom graphic layer 17 in a manner that allows the seed stamp 10 to be affixed to a card, gift or other article of interest.

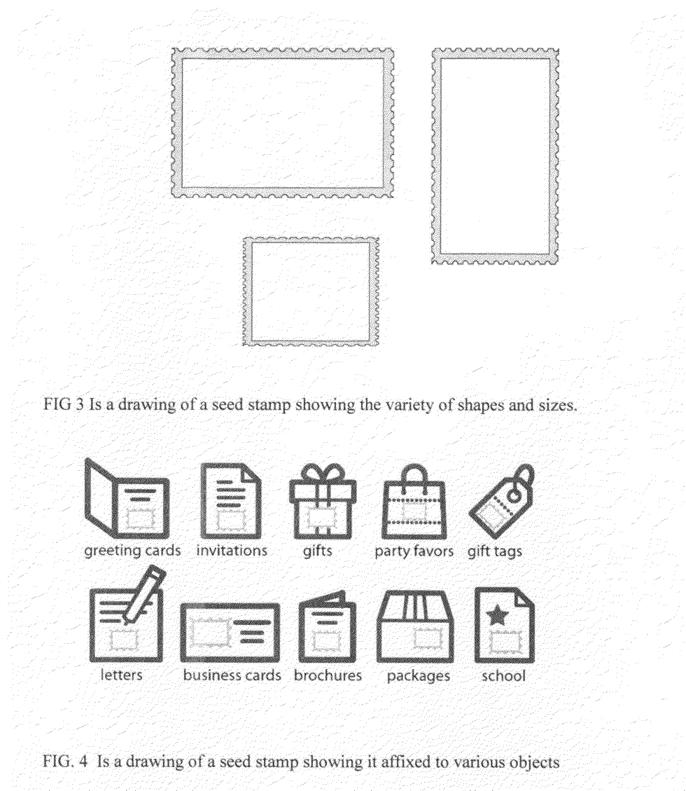

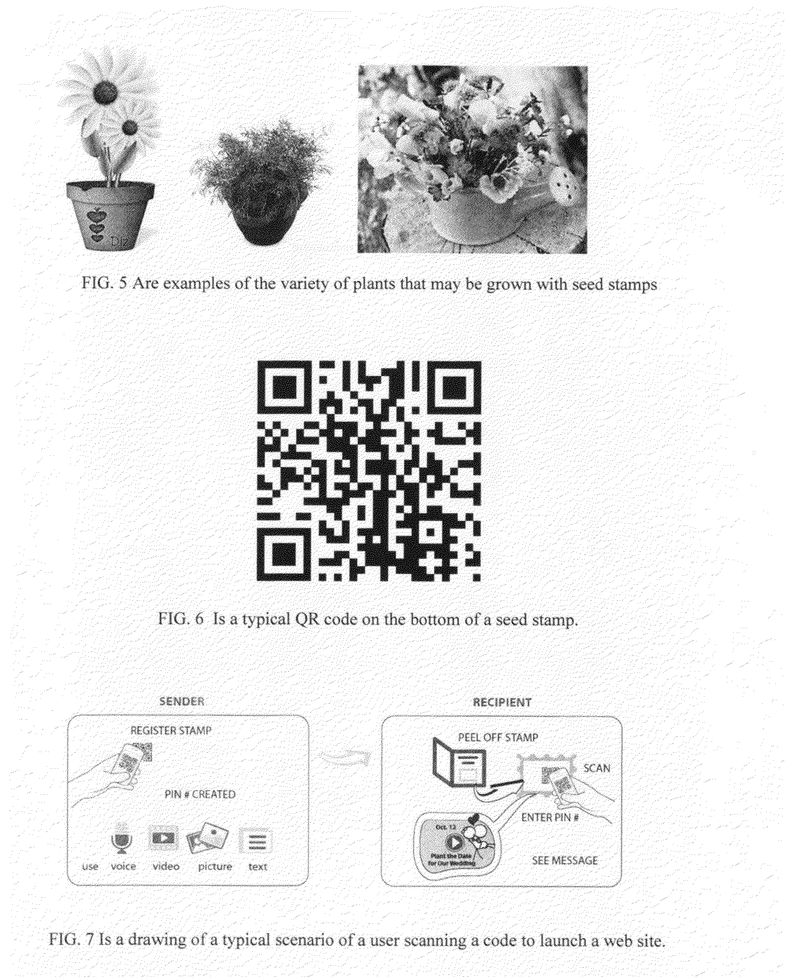

It is also shown that a variety of seed stamps shapes as shown in FIG. 3 may be produced with various graphics to match the season or occasion as shown in FIG. 1 respectively. Various objects may be used as the carrier of the seed stamp as shown in FIG. 4 which allows the seed stamp to be given in numerous ways. A typical QR tag that may be printed on the bottom of the stamp is shown in FIG. 6 with the steps required to read the tag and launch a web site as shown in FIG. 7. The final outcome of the seeded stamp is that of flowers, herbs or vegetables as shown in FIG. 5.

It is understood that while a certain form of the invention is illustrated, it is not to be limited to the specific form or arrangement of parts herein described and shown. It should be apparent to those skilled in the art that various changes may be made without departing from the scope of the invention and the invention is not to be considered limited to what is shown in the drawings and described in the specification. As such, although the description above contains many specificities, these should not be construed as limiting the scope of the invention but as merely providing illustrations of some of the presently preferred embodiments of this invention.

I claim:

1. A seed stamp comprising:
a top paper layer;
a bottom paper layer, substantially adhered to said top paper layer;
a seed layer comprising at least one seed, disposed between said top paper layer and said bottom paper layer; and
a bottom adhesive, located on a bottom paper layer bottom side, thereby allowing said seed stamp to be affixed to a seed stamp carrier.

2. The seed stamp of claim 1, further comprising a soluble layer, wherein said soluble layer is located substantially between said top paper layer and said seed layer.

3. The seed stamp of claim 1, wherein said top paper layer further comprises a top paper layer top side and a top paper layer bottom side, and wherein a top graphic layer is displayed upon said top paper layer top side.

4. The seed stamp of claim 3, wherein said top graphic layer comprises a seed related image, wherein there exists a relationship between the at least one seed of said seed layer and the seed related image.

5. The seed stamp of claim 3, wherein said top graphic layer comprises an occasion related image.

6. The seed stamp of claim 5, wherein said top graphic layer further comprises an occasion related image.

7. The seed stamp of claim 5, wherein said bottom paper layer further comprises a bottom paper layer top side and a bottom paper layer bottom side.

8. The seed stamp of claim 7, wherein a bottom graphic layer is displayed upon said bottom paper layer bottom side, and wherein said bottom adhesive is thereby disposed upon said bottom graphic layer.

9. The seed stamp of claim 8, wherein said bottom graphic layer comprises a machine readable code and wherein said bottom adhesive is sufficiently transparent so as to allow said machine readable code to be sufficiently read by a suitable electronic device.

10. The seed stamp of claim 9, wherein said machine readable code further comprises a quick response code.

11. The seed stamp of claim 10, further comprising an additional middle layer, wherein said additional middle layer is located between said top paper layer and said bottom paper layer.

12. The seed stamp of claim 11, wherein said additional middle layer further comprises a fertilizing agent, wherein said fertilizing agent assists the development of the at least one seed.

13. The seed stamp of claim 11, wherein said additional middle layer further comprises an expanding element, wherein expanding element will increase in volume upon contact with a liquid.

14. The seed stamp of claim 9, wherein said machine readable code directs said suitable electronic device to a seed stamp web site.

15. The seed stamp of claim 14, wherein a sender may access a seed stamp web site by means of said suitable electronic device and enter desired information therein.

16. The seed stamp of claim 15, wherein a receiver may access a seed stamp web site by means of said suitable electronic device and receive said desired information.

17. A method for utilization of a seed stamp between a sender to a receiver, said method comprising the steps of:
obtaining a seed stamp, wherein said step of obtaining a seed stamp is performed by a sender;
accessing a seed stamp web site by means of a suitable electronic device, wherein said step of accessing a seed stamp web site is accomplished by said sender by means of a machine readable code, said machine readable code being displayed on bottom paper layer bottom side of said seed stamp;
entering desired information to said seed stamp web site by said sender;
sending said seed stamp to a receiver by said sender;
secondarily accessing the seed stamp web site by the receiver; and
receiving said desired information from said seed stamp web site by the receiver.

18. The method of claim 17 further comprising the step of adhering said seed stamp to a carrier prior to the step of sending said seed stamp to a receiver by said sender.

19. The method of claim 18 further comprising the step of removing said seed stamp from said carrier by a receiver, said step of removing said seed stamp from said carrier by a receiver occurring prior to said step of secondarily accessing the seed stamp web site by the receiver.

20. The method of claim 19 further comprising the step of planting said seed stamp.

21. The method of claim 19 wherein said carrier is selected from the group consisting of cards, letters, pots, advertising material, gifts, food products, appliances, jewelry, bottles, cups and clothing.

22. A seed stamp comprising:
a top paper layer, and wherein said top paper layer further comprises a top paper layer top side and a top paper layer bottom side, and wherein a top graphic layer is displayed upon said top paper layer top side, and wherein said top graphic layer comprises a seed related image, wherein there exists a relationship between the at least one seed of said seed layer and the seed related image;
a bottom paper layer, substantially adhered to said top paper layer;
a seed layer comprising at least one seed, disposed between said top paper layer and said bottom paper layer;
a soluble layer, wherein said soluble layer is located substantially between said top paper layer and said seed layer;
and wherein said top paper layer and said bottom paper layer further comprise a gift card, wherein said gift card comprises a gift card machine readable code, and wherein said gift card machine readable code corresponds to a gift card value, wherein said gift card value may be stored in a computer memory and updated with use of said gift card.
